(19) United States
(12) Patent Application Publication
(10) Pub. No.: US 2006/0209559 A1
(43) Pub. Date: Sep. 21, 2006

(54) Telephone device with ornamental lighting

(76) Inventor: Boon Chen Lim, Quarry Bay (HK)

Correspondence Address: JACOBSON HOLMAN PLLC, 400 SEVENTH STREET N.W., SUITE 600, WASHINGTON, DC, 20004, US

(21) Appl. No.: 11/363,498

(22) Filed: Feb. 28, 2006

Related U.S. Application Data
(60) Provisional application No. 60/703,453, filed on Jul. 29, 2005.

(30) Foreign Application Priority Data
Mar. 1, 2005 (CN) 200520002758.5

(51) Int. Cl. F21V 7/04

(52) U.S. Cl. 362/555

(57) ABSTRACT

Various ornamental lighting for a telephone device or telephone add-on device, which consists of an LED as a light emitting source and light conductor material for forming various attractive ornamental lighting, such as the shape of a light emitting vase, a light emitting ring, light emitting strips with light emitting pearl, etc., for the devices. The ornamental lighting can be further combined with functional indicators of the device.

This is a complete application claiming benefit of provisional application Ser. No. 60/703,453, filed Jul. 29, 2005, hereby incorporated in its entirety by reference.

### FIELD OF THE INVENTION

The present invention relates to use of a light emitting diode (LED), and glass or perspex(Plexiglas) in the shape of a pipe or other shape to form a decorative light emitting ornament for a corded, cordless or mobile telephone, or a telephone add-on device, or a telephone supplemental device, such as a battery charger.

### BACKGROUND OF THE INVENTION

Conventional decorative telephones use a fluorescent lamp for lighting effect. However, a fluorescent lamp is not feasible for forming various decorative shapes, and is not convenient for various light emitting controls. Also, besides decoration, it is hard to combine a fluorescent lamp with a function indicator light of a telephone.

There has also been the use of a neon lamp for decorative telephone devices. Its flexibility in forming various shapes is better than that of fluorescent lamp. However, in the present invention, the use of LEDs and perspex (Plexiglas) allows further flexibility.

Another example for decorating a cordless phone is a Panasonic phone, Model No. KX-TG5240, which is equipped with a “visual ringer/light-up antenna” as described in the magazine Twice Daily.

A further example for decorating a cordless phone is a Motorola model 700 series phone, which is equipped with “enhanced lighting effects” as stated in the magazine Twice Daily. As stated in the magazine, this decoration is mainly the enhancement of the lighting effect of the keyboard by using a high brightness LED.

The present invention can be further expanded to form an independent decorative ornament, and of course, it can be added on or supplement any other device for decoration.

### SUMMARY OF THE INVENTION

High brightness light emitting diodes and other light emitting diodes of various colors have recently become available in the market. The present invention makes use of the characteristics of light, which can travel along/within a glass, light-conducting plastic or perspex (Plexiglas) pipe, or within other appropriate shapes, for which the incident angle of the light is larger than the reflection critical angle ‘c’ (e.g., in glass “c”=41.8 degrees). The light can be seen at certain angles or at the surface or position of the pipe or other shapes, where it is processed into semi-transparent or translucent surfaces, or with a certain angle, where light will be reflected and seen by the eye of a person.

Using a glass, light-conducting plastic or perspex (Plexiglas) pipe, various shapes can be formed. For example, the shapes of a ring, semi-ring, or the outer shape of a vase, or other shapes, can be formed, such as a corporate logo. With an LED in one terminal, or two LEDs at each respective terminal of the pipe for providing light emitting sources, the pipe can be processed into a translucent/semi-transparent surface for light reflection, such as a lighting vase, ring or other shapes, which can be seen by the eye when the LED is lit up.

The light pipes can also be a plurality of pipes with different colors of LEDs at the terminals of different pipes, and the pipes can be next to each other to form a multi-color figure, for example a rainbow shape, or other light emitting figures or objects.

Besides traveling along a pipe of perspex (Plexiglas), the light can also travel along other appropriate shapes of perspex (Plexiglas), and be reflected and be seen by the eye at certain appropriate positions with appropriate angles that is processed into a semi-transparent and rough surface.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the Telephone Device With Ornamental Lighting disclosed herein, and are for illustrative purposes only. Other embodiments that are substantially similar can use other components that have a different appearance.

FIG. 1 and FIG. 2 are illustrations of two cordless phones equipped with the ornamental lighting according to the present invention.

FIG. 3 is a sketch of FIG. 1 showing the detail of the light pipes in the cordless phone displayed in FIG. 1.

FIG. 4 shows a cordless phone base unit according to the present invention, wherein the ornamental lighting is semi-ring shaped.

FIG. 5 shows another cordless phone base according to the present invention, wherein in addition to the ring shaped light emitting pipes, a butterfly shaped light emitting object is located at the center of the ring.

FIG. 6 is a sketch of FIG. 5 showing the ring shaped light pipe and light emitting object at the center of the ring, and the LED light sources.

FIG. 7 shows another cordless phone base unit equipped with the ornamental lighting according to the present invention.

FIG. 8 shows the structure of the three separated light pipes of FIG. 7.

FIG. 9 shows another cordless phone base unit according to the present invention, which in addition to ring shaped light pipes also contains spherical light-emitting objects at the top of the pipes.

FIG. 10 shows another cordless phone handset according to the present invention, which has a light-emitting semi-ring at the top of the handset.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

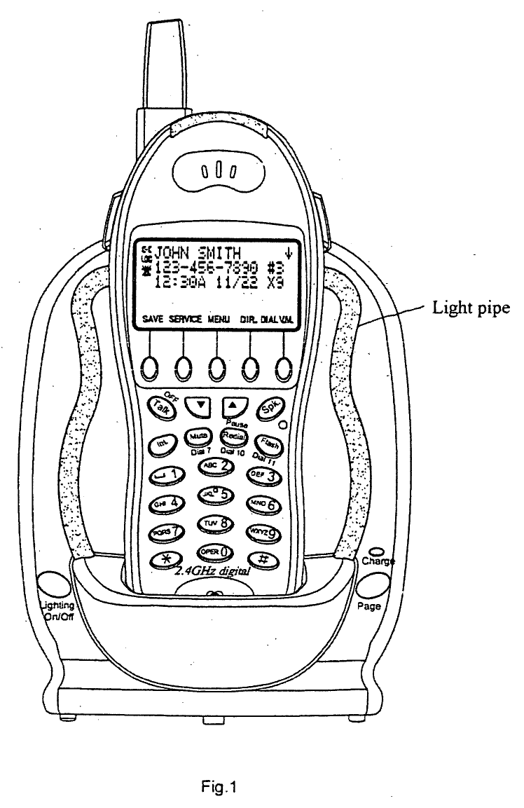

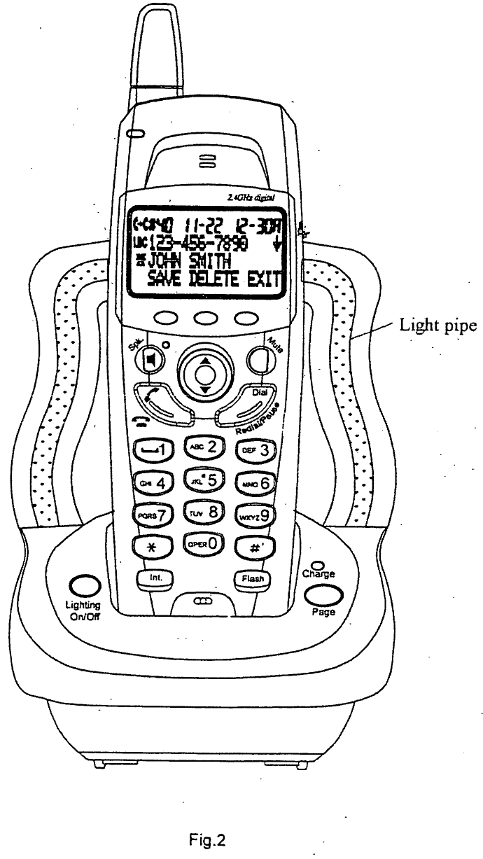

FIGS. 1 and 2 are illustrations of two sets of cordless telephones with ornamental lighting on the base unit. The ornamental lighting is in the shape of vases, formed with perspex (Plexiglas) pipes with two LEDs at both bottom terminals of the pipes on the base unit.

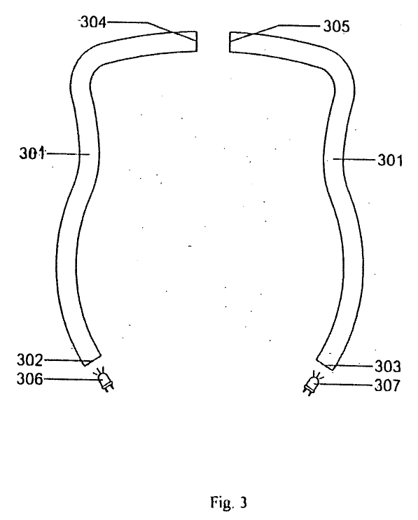

FIG. 3 is a sketch of FIG. 1 to show the details of the embodiment of the present invention. In order for the light to travel through all of the pipe, from the bottom terminals 302, 303 of the light pipes 301 in a vase shape, where on each side the LEDs 306, 307 are located, to the top 304, 305 of the light pipes 301 of the vase. The body and the surface of the light pipes 301 must be transparent except for a partial surface area, for example. The back of the pipe or the face of the pipe is processed into a translucent or semi-transparent appearance, in order to reflect the traveling light, and so can be seen by the eye.

The lighting of the vase shape can be simply controlled by an on/off switch, or simply light up whenever the power of the based unit is turned on. It can, also be combined with an incoming call signal, Caller ID of a new call, or line-in-use indicators. For example, in an embodiment of the present invention, the lighting vase shape would be flashing rapidly, when there is an incoming call which causes the phone to ring. In another embodiment of the present invention, the lighting vase shape would be flashing slowly, when the Caller ID of a new call is received. In yet another embodiment of the present invention, the lighting vase shape lights up steadily when the phone or phone line is in-use.

In yet another embodiment of the present invention, instead of simply flashing or lighting up steadily, different colors will be emitted by the ornamental shape when combined with the incoming call signal, Caller ID of new call, or line-in-use indicators. This is because it is desirable to have the decorative ornament be turned on and emitting light when the telephone is idle. If the ornamental lighting is turned off when the phone is idle, then the ornamental lighting cannot be seen by the user when there is no incoming call or outgoing call. Then as a result, a great deal of the aesthetic appeal of the ornamental lighting would be lost. Hence, to ensure the decorative function of the ornament is continuously served to the user, the ornamental lighting can be turned on all the time, even when the phone is idle and not in use. In this case, if the ornamental lighting is combined with an incoming call signal, Caller ID of a new call, or line-in-use indicators, according to the present invention, another color or a mix of colors can be emitted in response to these events.

For example, in an embodiment of the present invention, the blue light is continuously emitted by the decorative ornament when the phone is idle and not used. When there is an incoming call which causes the phone to ring, a red color light source would be turned on and flashing, so the lighting vase shape would be flashing rapidly in red color instead of the previous blue color. In addition, when the Caller ID of a new call is received, a red color light source would be turned on and flashing slowing, so the lighting vase shape would be flashing slowly in red color instead of the previous blue color. Moreover, when the phone or phone line is in-use, a red color light source would be turned on but not flashing, so the lighting vase shape would light up steadily in red color instead of blue color.

It should also be noted that because of the mixing effect of different colors of light, if the blue color light LED is not turned off when an incoming call signal, Caller ID of a new call, or line-in-use happens, the blue color light would be mixed with the red color light generated by the red color light source which is turned on or flashing, to produce purple color light in various patterns of flashing or steadily lit up according to the occurring event. Therefore, a light source of different colors can be used and mixed together to provide light of even more colors for the ornamental lighting.

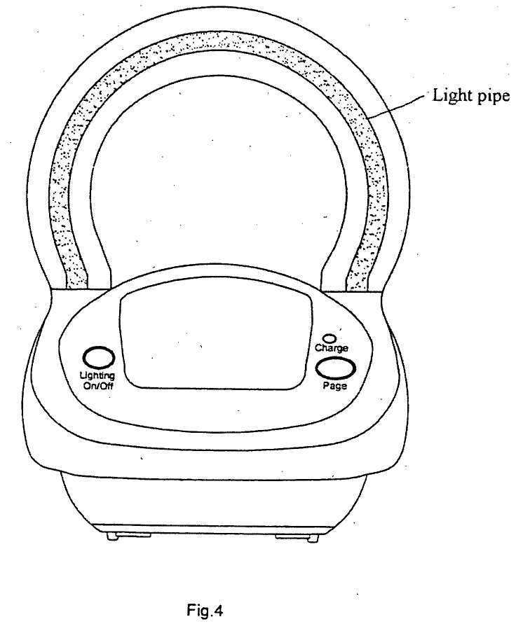

FIG. 4 shows another base unit of a cordless telephone which is an embodiment of the present invention. The light emitting decorative ornament is a semi-ring.

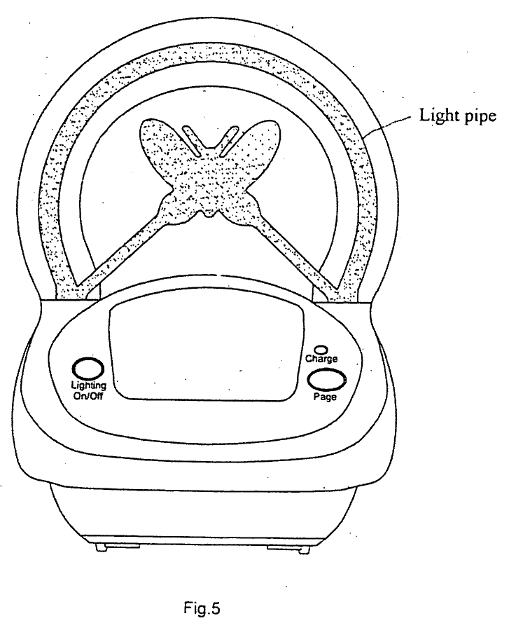

FIG. 5 shows another embodiment of the present invention with an enhanced further decorative light emitting ring with another light emitting figure, e.g., in the shape of a flower or a butterfly, which is located at the center of the ring. It is understood as being within the scope of the present invention that the pipes may take other forms, such as a corporate logo or the shape of a crown.

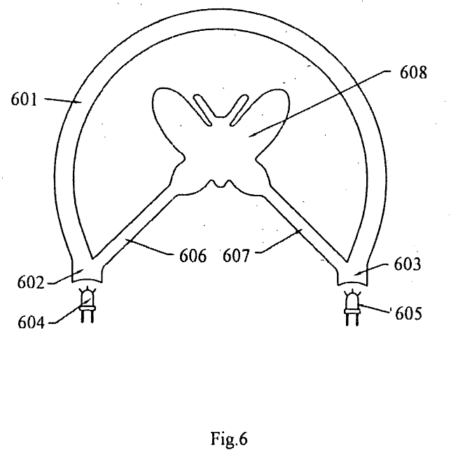

FIG. 6 is an outline drawing of the light emitting ring, the center object and the LED light source shown in FIG. 5. Two LEDs, 604 and 605 are under the bottom terminals 602 and 603 of the light pipe, and are shared by the ring 601 and the center object 608. There are two light pipes 606 and 607 which are connected between the bottom terminals 602, 603 of the ring 601 and the center object 608. Both the body and the surface of these light pipes 606, 607 should be highly transparent, in order to allow the light to travel with less loss. On the other hand, the surface of the center object 608 must be processed into translucent or semi-transparent portions at certain positions and sides, and with an appropriate angle for facilitating reflection of light. The process used to make the surface translucent or semi-transparent can be grinding, carving, painting or another suitable process.

According to this embodiment, a plurality of light pipes can be used to guide light from a common light emitting source to other objects, and the light emitting objects can be located at different positions from the common light source where appropriate, for the light to travel efficiently and enable the light to be seen. Similar to that as in FIGS. 1 and 2, the lighting means is combined with the incoming call signal, Caller ID of a new call, or line-in-use indicators.

It is well known that light of any color can be formed by mixing together an appropriate combination of red, blue and green light.

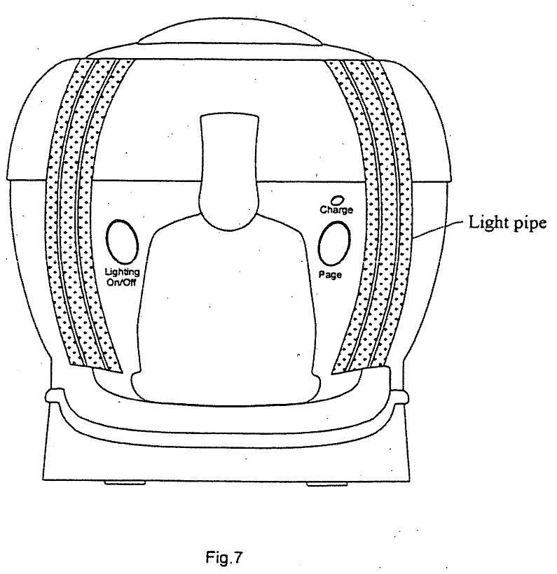

FIG. 7 shows another base unit of a cordless telephone that embodies the present invention. On each side of this base unit, there are three light pipes which would each emit different color light, and can be seen accordingly. Three different color LEDs can be used for the three light pipes. However, according to the present invention, one can use only two different color LEDs to form the three different color light emitting ornaments as shown in the figure. In this example, a blue and a red color are used to form a third purple color.

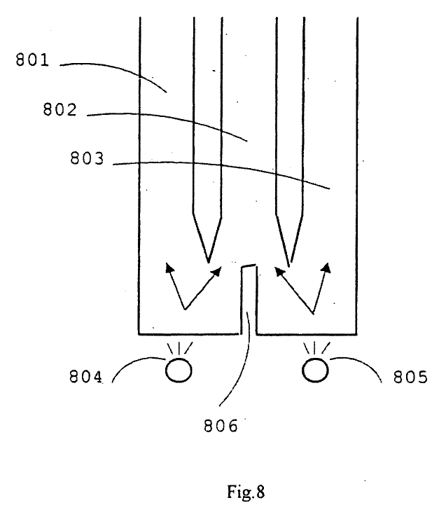

As shown in FIG. 8, 801,802 and 803 are the three light pipes, which are separate light pipes but connected together at their terminal. 804 and 805 are a blue LED and a red LED, respectively. These LEDs are located under the bottom terminals of the light pipes, where blue light emitted by blue LED 804 will be emitted for light pipes 801 and 802, and red light emitted by red LED 805 will be emitted for light pipes 803 and 802. Light pipe 802 receives both blue and red light, which as a result of the mixing together would form purple light. The gap 806 at the bottom of the light pipes would assist the light emitted by LED 804 to travel to light pipe 801, and resist the light emitted by LED 804 from traveling to light pipe 803. This of course also works in the other direction. The gap 806 would also assist the light emitted by LED 805 to travel to light pipe 803, and resist the light emitted by LED 805 to travel to light pipe 801.

Of course, a third color LED can be used for the middle light pipe 802. However, this would increase the complexity of the device and increase the cost. Especially if more color pipes, e.g., five or seven color pipes are used, the system or device would become quite complex. In fact, an LED of some color, for example, purple, is still not available in the market.

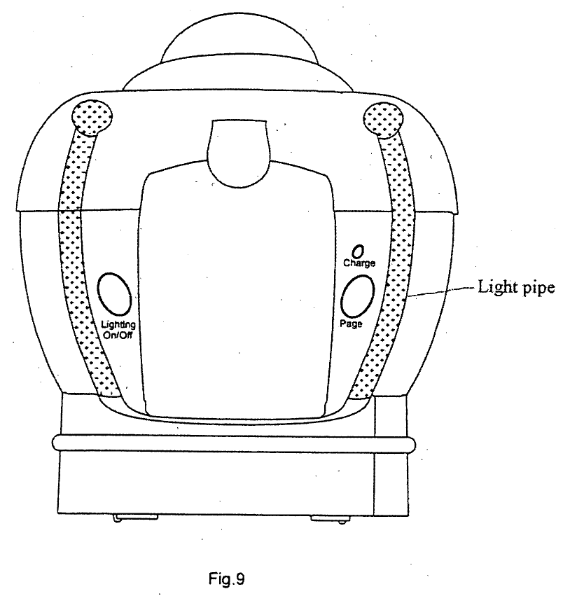

It should also be noted that the base unit of a cordless phone of FIG. 7 is in the shape of a crown. A crown of ornamental lighting pipes/stripes is more attractive. With a small spherical object simulating a light emitting pearl at the top of the pipe, it is made further attractive. An example of this is shown in FIG. 9. Furthermore, other than a small spherical object, objects with other shapes, which look attractive and suitable for light emitting, can also be used and put at the location at the top of the pipes.

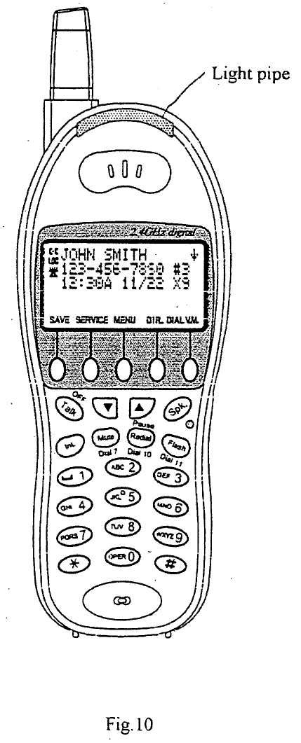

FIG. 10 shows another embodiment of the present invention, which is a cordless phone handset with a light-emitting semi-ring at the top of the handset. The same light emitting ring/semi-ring shape can also be combined with the incoming call signal, Caller ID of a new call, or line-in-use indicators.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A telephone device comprising:
an LED light emitting source, and
a light-conducting plastic or glass light emitting pipe conducting light from the LED light emitting source for conducting and emitting the light in various forms of ornamental lighting for the telephone device.

2. The telephone device as claimed in claim 1, wherein the light emitting pipe is an outer shape of a vase.

3. The device as claimed in claim 1, wherein the light emitting pipe is a shape of a ring or a semi-ring.

4. The device as claimed in claim 1, further comprising ornamental light emitting objects connected to the light emitting pipe.

5. The device as claimed in claim 3, further comprising a shape of a flower, a butterfly or logo of a company located at or close to a center of the ring or semi-ring.

6. The device as claimed in claim 1, wherein a shape of the light emitting pipe is a shape of a crown, with the light emitting pipe located on both sides of the crown.

7. The device as claimed in claim 6, further comprising small light emitting spherical objects locating at a top of the light emitting pipe.

8. The device as claimed in claim 1, wherein the light emitting pipe includes a plurality of different color LEDs.

9. The device as claimed in claim 8, wherein the different color LEDs mix colors in the light emitting pipe.

10. The device as claimed in claim 8, wherein the light emitting pipe is in a shape of a rainbow.

11. The device as claimed in claim 1, wherein the light emitting pipe is combined with at least one of functional indicators of the telephone device.

12. The device as claimed in claim 11, wherein the functional indicators are incoming call ring indicator, new Caller ID indicator and line-in-use indicator.

13. The device as claimed in claim 1, wherein the light emitting device is turned on continuously and emits one color when the telephone is idle and changes to emit another color when combined with at least one of functional indicators of the telephone device.

14. The device as claimed in claim 13, wherein the functional indicators are incoming call ring indicator, new Caller ID indicator and line-in-use indicator.

15. The device as claimed in claim 1, wherein there are multiple light emitting pipes and a number of said light emitting pipes is larger than a number of different color LEDs that act as light sources, so the color of some of the light emitting pipes is generated by mixing of light from two or more of said color LEDs.

16. The device as claimed in claim 15, wherein one or more gaps are inserted between the light emitting pipes, which block light from some of said color LEDs from going to some of the light emitting pipes, while still allowing light from some of said color LEDs to travel to some others of said light emitting pipes.
